(19) United States
(12) Patent Application Publication
(10) Pub. No.: US 2010/0096092 A1
(43) Pub. Date: Apr. 22, 2010

(54) Garage door assembly

(75) Inventors: Heng Liu, Taiwan (TW); Yi Cheng Hsiung, Taipei Hsien (TW)

Correspondence Address: EDWARDS ANGELL PALMER & DODGE LLP, P.O. BOX 55874, BOSTON, MA, 02205, US

(73) Assignee: Shanghai Guardian Corp., Shanghai (CN)

(21) Appl. No.: 12/288,643

(22) Filed: Oct. 22, 2008

(51) Int. Cl. E05F 15/20

(52) U.S. Cl. 160/310; 49/31; 160/238; 49/506; 49/70

(57) ABSTRACT

A garage door assembly including a door for enclosing an opening, and a mechanism for selectively deploying the door in a closed position to cover the opening, and an open position with the door stored leaving the opening open. A position reading assembly monitors a position of the door with respect to the opening. The position reading assembly includes a controller and three switches in communication with the controller. The switches are positioned such that movement of the door actuates the three switches and, in turn, the controller divides the door into eight virtual zones between the closed and open positions.

### BACKGROUND OF THE DISCLOSURE

1. Field of the Disclosure

The subject disclosure relates to a garage door assembly, and more particularly to an improved position reading assembly for determining and controlling position of a garage door of the assembly.

2. Background of the Related Art

Garage door assemblies are used to cover openings of all sizes. Use of garage door assemblies has been widely used and well understood in the art. Some examples are illustrated in U.S. Pat. No. 6,806,672 to Fitzgibbon et al. ('672 patent), U.S. Patent Application 2005/0140323 to Fitzgibbon et al. (2005/0140323 application), U.S. Pat. No. 6,878,927 to Smith et al. ('927 patent), U.S. Pat. No. 6,956,199 to Smith et al. ('199 patent), and U.S. Patent Application 2002/0175276 to Smith et al. (2002/0175276 application), each of which is incorporated herein by reference.

The '672 patent and the 2005/0140323 application disclose movable barrier operators with a microprocessor 300 that provides the signals which start the motor 116, control the direction of rotation, and the speed of rotation. (See '672 patent column 9, ll. 38-41; 2005/0140323 application paragraph 0060). The '672 patent and 2005/0140323 application discloses an RPM sensor module in the motor 118. (See '672 patent column 4, ll. 11-33; column 10, ll. 9-10, 2005/0140323 application paragraph 0017). The '672 patent discloses a subroutine that checks the position of the door. (See column 20, ll. 48-60, 220/0140323 paragraph 0094).

The '927 patent, the '199 patent and the 2002/0175276 application also disclose movable barrier operators with an absolute position detector that provides a unique value for each position along the path of travel. The absolute position detector uses two binary serial streams and one clock stream. After the first five cycles of the clock stream, the binary serial streams can be decoded by a microprocessor to produce an absolute position indication. The absolute position is calculated given the bit streams and the clock pulse. (See '927 patent and '199 patent column 2, ll. 15-column 3, ll. 30; 2002/0175275 application paragraphs 34-47).

### SUMMARY OF THE INVENTION

There are problems associated with prior art garage door assemblies such as undesirable complexity, high cost, cumbersome operation and poor reliability. A need exists for a reliable, cost-effective garage door assembly that constantly monitors the position of the door and can recover properly in the event of a power failure.

The present disclosure is directed to a garage door assembly having three position readers within the same unit. The three position readers are used to ascertain measurements that virtually divide the door into eight sections to determine the position of the door. Preferably, the garage door assembly further includes an additional reader to determine a location of the door within each of the eight virtual sections.

Another embodiment of the present disclosure includes a garage door assembly including a door for enclosing an opening, and a mechanism for selectively deploying the door in a closed position to cover the opening, and an open position with the door stored leaving the opening uncovered. A position reading assembly monitors a position of the door with respect to the opening. The position reading assembly includes a controller and three switches in communication with the controller. The switches are positioned such that movement of the door actuates the three switches and, in turn, the controller divides the door into eight virtual zones between the closed and open positions.

The garage door assembly may further include an intra-section reader for monitoring position of the door within each zone. In one embodiment, the door is flexible and wraps around a reel in the closed position. The garage door assembly may also include a gearing mechanism assembly for wrapping and unwrapping the door, a tracking wheel coupled to the gearing mechanism such that movement of the door from the fully open to the fully closed position results in a single rotation of the tracking wheel and sensor activating means mounted on the tracking wheel for activating the three switches. The sensor activating means may be a flag, a varying diameter, markings, a magnet, an RFID component, and combinations thereof.

The present technology is also directed to a method for operating a garage door including the steps of providing three switches on the garage door that operate to divide the garage door into eight virtual zones. Upon restart after power loss, the three switches are polled to determine which of the eight virtual zones the garage door is located in. If the garage door is oriented such that the garage door is almost or fully open based upon the polling, a position of the garage door is reset by moving the garage door downward until the garage door enters the adjacent virtual zone. The method may also perform the step of, if the garage door is at least one virtual zone away from being fully open based upon the polling, resetting the position of the garage door to fully open by moving the garage door upward. Still further, the method may also determine upper and lower travel limits of the garage door by polling the three switches and/or providing an intra-zone reader to track a position of the garage door within each zone.

It should be appreciated that the present invention can be implemented and utilized in numerous ways, including without limitation as a process, an apparatus, a system, a device, a method for applications now known and later developed. These and other unique features of the system disclosed herein will become more readily apparent from the following description and the accompanying drawings.

### BRIEF DESCRIPTION OF THE DRAWINGS

So that those having ordinary skill in the art to which the disclosed system appertains will more readily understand how to make and use the same, reference may be had to the drawings.

FIG. 1 illustrates a perspective view of a garage door assembly constructed in accordance with a preferred embodiment of the subject disclosure with the housing of the position reading assembly partially cut away.

FIG. 2 illustrates a perspective view of the position reading assembly of FIG. 1.

FIG. 3 illustrates an plan view of another position reading assembly in accordance with the subject disclosure.

### DETAILED DESCRIPTION OF PREFERRED EMBODIMENTS

The present disclosure overcomes many of the prior art problems associated with garage door openers. The advantages, and other features of the system disclosed herein, will become more readily apparent to those having ordinary skill in the art from the following detailed description of certain preferred embodiments taken in conjunction with the drawings which set forth representative embodiments of the present invention and wherein like reference numerals identify similar structural elements.

All relative descriptions herein such as left, right, up, and down are with reference to the Figures, and not meant in a limiting sense. Unless otherwise specified, the illustrated embodiments can be understood as providing exemplary features of varying detail of certain embodiments, and therefore, unless otherwise specified, features, components, modules, elements, and/or aspects of the illustrations can be otherwise combined, interconnected, sequenced, separated, interchanged, positioned, and/or rearranged without materially departing from the disclosed systems or methods. Additionally, the shapes and sizes of components are also exemplary and unless otherwise specified, can be altered without materially affecting or limiting the disclosed technology.

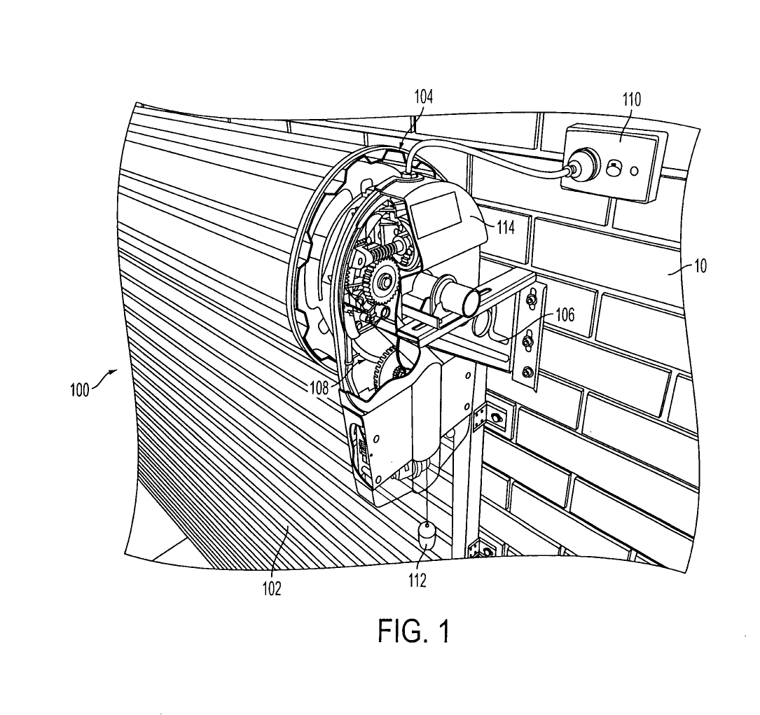

Now referring to FIG. 1, a perspective view of a garage door assembly constructed in accordance with a preferred embodiment of the subject disclosure is illustrated and referred to generally by the reference numeral 100. The garage door assembly 100 is used to selectively cover an opening in a building 10. Normally, the garage door assembly 100 is mounted at the top of the opening and descends but other configurations would also be able to successfully employ the subject technology.

The garage door assembly 100 includes a door 102 that winds onto a reel assembly 104. The reel assembly 104 is mounted to the wall by a bracket 106. A position reading assembly 108 couples to the reel assembly 104 and is powered by an outlet 110. The position reading assembly 108 includes a motor (not explicitly shown) for winding and unwinding the door 102 from the reel assembly 104. A manual switch 112 hangs from the position reading assembly 108 to manually operate the garage door assembly 100. The garage door assembly 100 may also be operated by a remote switch as is well known in the art.

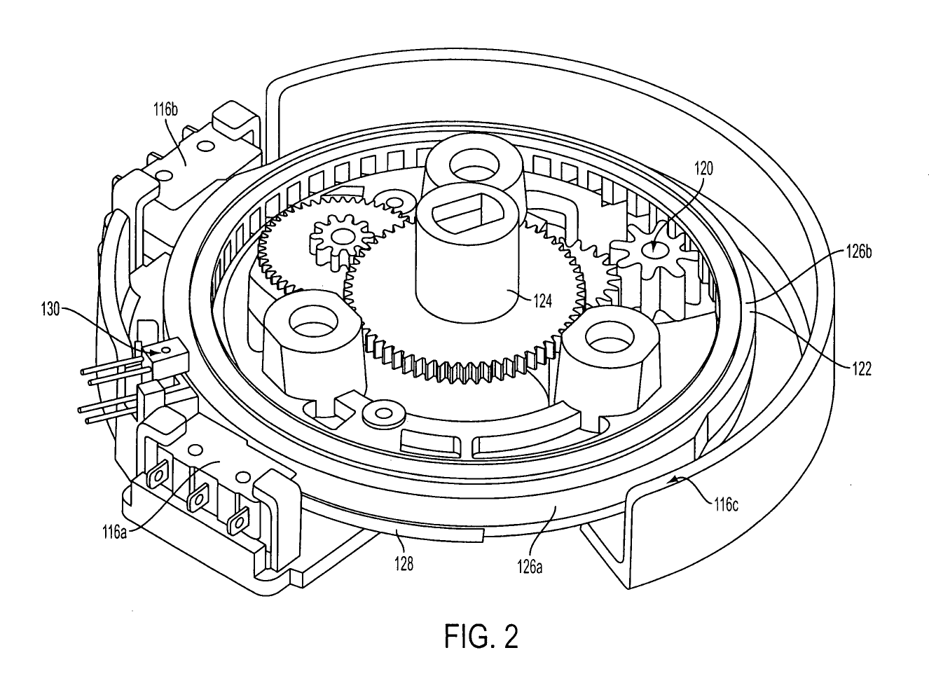

The position reading assembly 108 includes components (best seen in FIG. 2) contained within a housing 114 to prevent dust and like contaminants from interfering with proper operation. In FIG. 1, the housing 114 of the position reading assembly 108 is shown partially cut away.

Referring to FIG. 2, a perspective view of the components of the position reading assembly 108 is illustrated. The position reading assembly 108 virtually divides the door 102 into eight sections. The position reading assembly 108 has three sensors 116a-c. Although sensor 116c is not shown explicitly, an approximate location is noted on FIG. 2. Each sensor 116a-c has two states, ON and OFF. Thus, eight different combinations of sensor states are possible, one for each virtual section. In one embodiment, the door 102 is 400 cm. and each virtual door section is 50 cm.

Each sensor 116a-c is fixed in place on a frame 118 that surrounds a gearing assembly 120. The gearing assembly 120 includes a rotational tracking wheel 122 that interacts with the sensors 116a-c. The gearing assembly 120 is coupled to the reel assembly 104 so that the tracking wheel 122 completes approximately one rotation when the door 102 moves from fully open to fully closed. In one embodiment, a central hub 124 couples to the motor or rotating rod (not explicitly shown) supporting the door 102. As the central hub 124 rotates, a plurality of gears in the gearing assembly 120 translate the motion into the required single rotation of the tracking wheel 122.

In one embodiment, the sensors 116a, 116b are mechanical switches, e.g., switches with extending arms that move between an ON and OFF position to generate corresponding electrical signals. The sensor 116c is a photo interrupter that changes state when a beam of energy is blocked. The sensors 116a-c may be normally ON or OFF as desired. In the embodiment of FIG. 2, the sensors 116a-c are separated by 90 degrees about the periphery of the tracking wheel 122.

The tracking wheel 122 has equal and opposing portions 126a, 126b of two different diameters to interact with the sensors 116a, 116b. The tracking wheel 122 has a relatively larger diameter at portion 126a. A series of four flags 128 (only one can be seen) are equally spaced and peripherally mounted to interact with the sensor 116c. Each flag 128 spans 45 degrees with 45 degree spaces therebetween.

In the orientation of FIG. 2, it can be seen that sensors 116a, 116b would be activated (e.g., an ON state if normally OFF) by the thicker diameter portion 126a. Although out of view, the sensor 116c would also have a flag 128 interacting therewith to be activated (e.g., an ON state if normally OFF). As the door 102 moves through the virtual sections, the tracking wheel 122 rotates and the state of the sensors 116a-c changes.

For example, see Table 1 below that illustrates the various sensor states as the door 102 moves on and off the reel assembly 104 and, in turn, the tracking wheel 122 rotates. Table 1 is based on the orientation illustrated in FIG. 2 being a fully open position but the subject technology is not limited to such.

TABLE 1

| Virtual Door | Amount of | | | |
|---|---|---|---|---|
| Section Descending | Clockwise | Sensor | Sensor | Sensor |
| into Opening | Rotation | 116a | 116b | 116c |
| none | Fully open, no | 1 | 1 | 1 |
| | rotation from FIG. 2 | | | |
| 1 of 8 | 1-45 degrees | 1 | 1 | 1 |
| 1 and 2 of 8 | 46-90 degrees | 1 | 1 | 0 |
| 1-3 of 8 | 91-135 degrees | 0 | 1 | 1 |
| 1-4 of 8 | 136-180 degreees | 0 | 1 | 0 |
| 1-5 of 8 | 181-225 degrees | 0 | 0 | 1 |
| 1-6 of 8 | 226-270 degrees | 0 | 0 | 0 |
| 1-7 of 8 | 271-315 degrees | 1 | 0 | 1 |
| 1-8 of 8 | 316-360 degrees | 1 | 0 | 0 |
| 8 of 8 fully | Fully Closed - | 1 | 0 | 0 |
| deployed | 360 degrees | | | |

As can be seen from Table 1, each virtual section of the door 102 corresponds to 45 degrees of rotational travel of the tracking wheel 122. The position reading assembly 108 and/or control electronics associated therewith can be programmed to recognize upper and lower travel limits upon certain changes in sensor values. For example, if sensors 116a-c switch from respective states ON, OFF, OFF to ON, ON, ON, then the door has been fully closed. Similarly, if sensors 116a-c switch from respective states ON, ON, ON to ON, OFF, OFF, then the door has been fully opened. As the tracking wheel 122 normally moves back and forth, these conditions would only occur at the limits of travel. Alternatively, separate sensors (not shown) may be coupled to the door 102 in order to determine the fully open and closed positions.

Still referring to FIG. 2, the position reading assembly 108 also includes an intra-section position reader 130. Thus, when the door 102 and, in turn, the tracking wheel 122 pass from one virtual section to another, the intra-section position reader 130 begins tracking the intra-section movement. Preferably, the resolution of the intra-section position reader 130 is five hundred finer sections within each fifty centimeter virtual section. In one embodiment, the intra-section position reader 130 includes alternating lines and spaces on the periphery of the tracking wheel 122 that are read by an encoder assembly. Alternatively, the motor of the position reading assembly 108 may be encoded to track movement thereof to provide the intra-section readings.

The garage door assembly 100 can recover from a lost power situation. For example, upon power up, the garage door assembly 100 may be programmed to move to the up limit position, e.g., fully open. When power is restored to the garage door assembly 100, the position reading assembly 108 can poll the sensors 116a-c to determine roughly where the virtual sections of the door 102 are.

If the door 102 is positioned such that the door 102 is within a virtual section from being fully open (e.g., the sensors 116a-c reading ON, ON, ON), the position reading assembly 108 can send the door 102 downward until the reading of sensor 116c changes to OFF. At this point, the position reading assembly 108 can recognize that the door 102 is approximately one virtual section from fully open and proceed to that position. In one embodiment, the reversal of door direction would occur, as the sensor 116c changes back to an ON state, the intra-section position reader 130 would be reset to properly track door movement to the open position. In another position, the door is in a different section, the position reading assembly 108 recognized this and directs movement upward so that the last virtual section is reeled in with the process noted above starting. In another embodiment, upon finding the bottom of the first virtual section, the intra-section position reader 130 is used to set the fully open position.

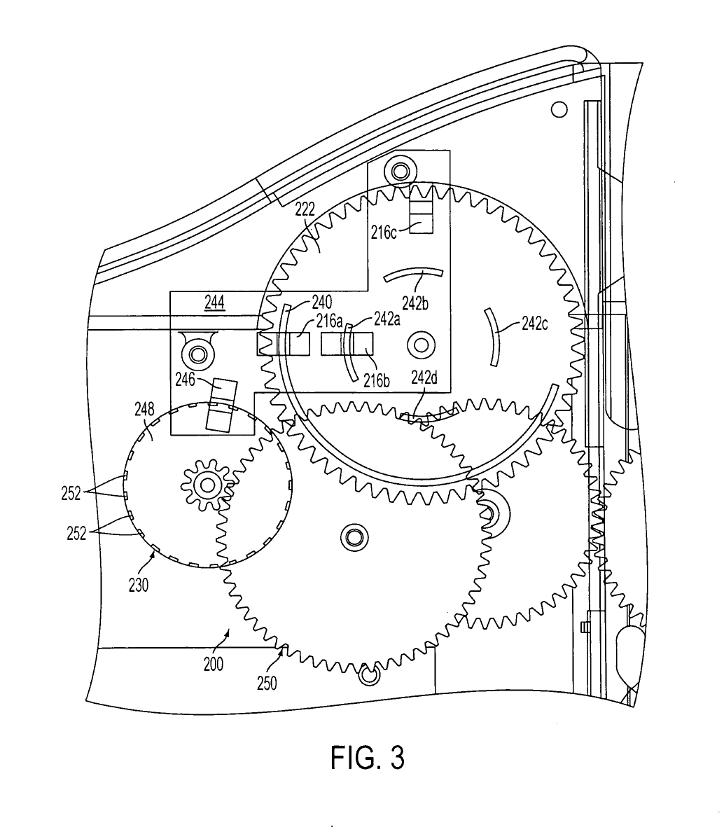

FIG. 3 illustrates an plan view of another position reading assembly 200 in accordance with the subject disclosure. The orientation of FIG. 3 is such that the door has just entered the first virtual section, i.e., the door has just begun to cover the building opening. As will be appreciated by those of ordinary skill in the pertinent art, the position reading assembly 200 utilizes similar principles to the position reading assembly 100 described above. Accordingly, like reference numerals preceded by the numeral “2” instead of the numeral “1”, are used to indicate like elements. The following discussion is directed to the differences. Some primary differences of the position reading assembly 200 in comparison to the position reading assembly 100 is the use of three photo interrupter sensors 216a-c rearranged to interact with five flags 240, 242a-d and a different intra-section position reader assembly 230.

The sensors 216a-c and intra-section position reader 230 are mounted on a sensor plate 244. Sensors 216a, 216c remain separated by 90 degrees but sensor 216b has been repackaged adjacent to sensor 216a and radially inward with respect to the tracking wheel 222. The flags 240, 242a-d depend from the tracking wheel 222 to interact with the sensors 216a-c, wherein each sensor 216a-c is a photo-interrupter. The large flag 240 is approximately a 180 degree arc that will pass through sensors 216a, 216c whereas the four smaller flags 242a-d are four equally spaced, approximately 45 degree arcs that will pass through sensor 216b. An exemplary chart illustrating the sensor 216a-c reading is shown below in Table 2.

TABLE 2

| Virtual Door | Amount of | | | |
|---|---|---|---|---|
| Section Descending | Clockwise | Sensor | Sensor | Sensor |
| into Opening | Rotation | 216a | 216b | 216c |
| none | Fully open | 1 | 1 | 0 |
| | as shown in FIG. 3 | | | |
| 1 of 8 | 1-45 degrees | 1 | 1 | 0 |
| 1 and 2 of 8 | 46-90 degrees | 1 | 0 | 1 |
| 1-3 of 8 | 91-135 degrees | 1 | 1 | 1 |
| 1-4 of 8 | 136-180 degreees | 1 | 0 | 1 |
| 1-5 of 8 | 181-225 degrees | 0 | 1 | 1 |
| 1-6 of 8 | 226-270 degrees | 0 | 0 | 0 |
| 1-7 of 8 | 271-315 degrees | 0 | 1 | 0 |
| 1-8 of 8 | 316-360 degrees | 0 | 0 | 0 |
| 8 of 8 fully | Fully Closed - | 0 | 0 | 0 |
| deployed | 360 degrees | | | |

The intra-section position reader 230 includes a photo-interrupter sensor 246 mounted on the plate 244 and a gear 248 coupled to the motion mechanism 250 of the door (not shown). The motion mechanism 250 and gear 248 are configured such that one full rotation of the gear 248 corresponds to the linear movement of the door through one virtual section. The gear 248 also includes a plurality of depending flags 252 for changing the state of the sensor 246. For example, when a virtual section is 50 cm., the gear 248 has twenty-five equally sized and spaced flags 252. Hence, by passing through a full rotation, the gear 248 will generate 50 changes of state for the sensor 246, each state corresponding to a centimeter of door travel.

In another embodiment, the door rides in a track. Accordingly, a position reading mechanism is mounted at the top of the opening. Such a position reading mechanism would include three optical interrupter sensors, each sensor aligned with a different location. Flags would extend from the door to change the state of the interrupter sensors and, thereby, segment the door into virtual sections.

For example, a single flag that extends across the bottom four virtual sections could be aligned to pass through sensor A. Regarding sensor B, two flags would pass there through. One of the sensor B flags would extend across the bottom two virtual sections and the other would extend across the third and fourth sections from the top. Lastly, a series of four flags would align with sensor C, each flag extending from alternating virtual sections. An exemplary chart illustrating this sensor and flag scheme is shown below in Table 3.

TABLE 3

| Virtual Door Section | Sensor A | Sensor B | Sensor C |
|---|---|---|---|
| 1 | 0 | 0 | 0 |
| 2 | 0 | 0 | 1 |
| 3 | 0 | 1 | 0 |
| 4 | 0 | 1 | 1 |
| 5 | 1 | 0 | 0 |
| 6 | 1 | 0 | 1 |
| 7 | 1 | 1 | 0 |
| 8 | 1 | 1 | 1 |

In still other embodiments, the sensing arrangements are different technology now known or later developed such as RFID, linear encoders, hall effect magnetic switches and combinations of the same. As would be appreciated by those of ordinary skill in the pertinent art, the functions of several elements may, in alternative embodiments, be carried out by fewer elements, or a single element. Similarly, in some embodiments, any functional element may perform fewer, or different, operations than those described with respect to the illustrated embodiment.

Also, functional elements shown as distinct for purposes of illustration may be incorporated within other functional elements, separated in different hardware or distributed in various ways in a particular implementation. Further, relative size and location are merely somewhat schematic and it is understood that not only the same but many other embodiments could have varying depictions. Additionally, each claim may depend from any or all claims in a multiple dependent manner even though such has not been originally claimed.

While the invention has been described with respect to preferred embodiments, those skilled in the art will readily appreciate that various changes and/or modifications can be made to the invention without departing from the spirit or scope of the invention as defined by the appended claims.

What is claimed is:

1. A garage door assembly comprising:
a door for enclosing an opening;
a mechanism for selectively deploying the door in a closed position to cover the opening, and an open position with the door stored leaving the opening open; and
a position reading assembly for monitoring a position of the door with respect to the opening, the position reading assembly including: a controller; and three switches in communication with the controller,
wherein the switches are positioned such that movement of the door actuates the three switches and, in turn, the controller divides the door into eight virtual zones between the closed and open positions.

2. A garage door assembly as recited in claim 1, further comprising an intra-section reader for monitoring position of the door within each zone.

3. A garage door assembly as recited in claim 1, wherein the door is flexible and wraps around a reel in the closed position.

4. A garage door assembly as recited in claim 3, further comprising:
a gearing mechanism assembly for wrapping and unwrapping the door;
a tracking wheel coupled to the gearing mechanism such that movement of the door from the fully open to the fully closed position results in a single rotation of the tracking wheel; and
sensor activating means mounted on the tracking wheel for activating the three switches.

5. A garage door assembly as recited in claim 1, wherein the sensor activating means is selected from the group consisting of a flag, a varying diameter, markings, a magnet, an RFID component, and combinations thereof.

6. A garage door assembly as recited in claim 1, wherein each switch is about 90 degrees from another switch.

7. A garage door assembly as recited in claim 1,
wherein the three switches are a first optical switch, a second optical switch and a third optical switch, each switch being aligned in a different plane, and
further comprising three series of flags extending from the door, each series aligned in one of the different planes such that
when the first zone enters the reel mechanism as the flexible door moves from the closed position to the open position, all three switches are a logic low,
when the second zone enters the reel mechanism, the first switch is a logic low, the second switch is a logic low and the third switch is a logic high,
when the third zone enters the reel mechanism, the first switch is a logic low, the second switch is a logic high and the third switch is a logic low,
when the fourth zone enters the reel mechanism, the first switch is a logic low, the second switch is a logic high and the third switch is a logic high,
when the fifth zone enters the reel mechanism, the first switch is a logic high, the second switch is a logic low and the third switch is a logic low,
when the sixth zone enters the reel mechanism, the first switch is a logic high, the second switch is a logic low and the third switch is a logic high,
when the seventh zone enters the reel mechanism, the first switch is a logic high, the second switch is a logic high and the third switch is a logic low,
when the eighth zone enters the reel mechanism, the first switch is a logic high, the second switch is a logic high and the third switch is a logic high.

8. A method for operating a garage door comprising the steps of:
providing three switches on the garage door that operate to divide the garage door into eight virtual zones;
upon restart after power loss, determining which of the eight virtual zones the garage door is in by polling the three switches; and
if the garage door is oriented such that the garage door is almost or fully open based upon the polling, resetting a position of the garage door by moving the garage door downward until the garage door enters the adjacent virtual zone.

9. A method as recited in claim 8, further comprising the step of: if the garage door is at least one virtual zone away from being fully open based upon the polling, resetting the position of the garage door to fully open by moving the garage door upward.

10. A method as recited in claim 8, further comprising the step of: determining upper and lower travel limits of the garage door by polling the three switches.

11. A method as recited in claim 8, further comprising the step of providing an intra-zone reader to track a position of the garage door within each zone.

12. A method as recited in claim 8, further comprising the step of using an intra-section position reader to move the garage door to the fully open position.

13. A garage door assembly comprising:
a door for enclosing an opening;
a mechanism for selectively deploying the door in a closed position to cover the opening, and an open position with the door stored leaving the opening open; and
a position reading assembly for monitoring a position of the door with respect to the opening, the position reading assembly including: a mounting plate having first, second and third photo interrupter sensors; and a tracking wheel having a semi-circle shaped flag and four arcuate flags, wherein the arcuate flags are equally sized and spaced about a central point of the tracking wheel such that movement of the door moves the tracking wheel and thereby the semi-circle shaped flag passes through the first and second photo interrupter sensors and the four arcutate flags pass through the third photo interrupter sensor to define eight virtual zones between the closed and open positions.

14. A garage door assembly as recited in claim 13, wherein the first and second photo interrupter sensors are mounted approximately 90 degrees apart on the mounting plate.

15. A garage door assembly as recited in claim 13, wherein the four arcuate flags are 45 degree arcs.

16. A garage door assembly as recited in claim 13, further comprising an intra-section position reader coupled to the mounting plate and a positional gear coupled coupled to the door for movement therewith, wherein the position reader and positional gear interact to allow for tracking door position within each virtual zone.
